(19) United States
(12) Patent Application Publication
(10) Pub. No.: US 2012/0113372 A1
(43) Pub. Date: May 10, 2012

(54) LIQUID CRYSTAL DISPLAY PANEL

(75) Inventors: Takayuki Kato, Tottori (JP); Mizuho Mitani, Tottori (JP)

(73) Assignee: SONY CORPORATION, Tokyo (JP)

(21) Appl. No.: 13/010,423

(22) Filed: Jan. 20, 2011

(30) Foreign Application Priority Data
Jul. 2, 2008 (JP) P2008-173103

(51) Int. Cl. G02F 1/1333

(52) U.S. Cl. 349/138

(57) ABSTRACT

A liquid crystal display panel is provided and includes substrates opposed to each other with a liquid crystal layer interposed therebetween, one of the substrates including gate and common lines disposed in parallel, source lines intersecting the gate and common lines, and switching elements in the vicinities of intersections of the gate and source lines. A lower electrode of a transparent conductive material and an upper electrode with slits are stacked with an insulating film interposed therebetween for each area defined by the gate and source lines. The upper electrode and the lower electrode are electrically connected to the corresponding switching element and the corresponding common line, respectively. The insulating film has a multi-layered structure of first and second insulating films close to the substrate and the liquid crystal layer, respectively. The surface of the lower electrode is covered with the first insulating film. The gate and common lines are formed on the surface of the first insulating film. The common line is electrically connected to the lower electrode via a contact hole formed in the first insulating film.

### CROSS REFERENCES TO RELATED APPLICATIONS

The present application contains subject matter related to that disclosed in Japanese Priority patent application JP 2008-173103 filed in the Japan Patent Office on Jul. 2, 2008, the entire contents of which is hereby incorporated by reference.

### BACKGROUND

The present disclosure relates to a liquid crystal display panel of an FFS (Fringe Field Switching) mode, and more particularly, to a liquid crystal display panel of an FFS mode which can suppress a disconnection of gate lines due to a scratch formed in a glass substrate and in which the surface of a lower electrode is not roughened at the time of forming the gate lines and common lines.

A liquid crystal display panel has characteristics that it is smaller in weight, thickness, and power consumption than a CRT (Cathode Ray Tube) and thus is widely used in many electronic apparatuses for display. The liquid crystal display panel serves to align liquid crystal molecules in a predetermined direction by performing a rubbing process on an alignment film, to change the direction of the liquid crystal molecules aligned with an electric field applied thereto, and to change an amount of transmitted or reflected light to display an image.

The methods of applying an electric field to a liquid crystal layer of a liquid crystal display panel can be classified into a vertical electric field type and a horizontal electric field type. In the vertical electric field type of liquid crystal display panel, a roughly vertical electric field is applied to liquid crystal molecules by a pair of electrodes interposing a liquid crystal layer therebetween. Examples of such a vertical electric field type of liquid crystal display panel include liquid crystal panels of a TN (Twisted Nematic) mode, a VA (Vertical Alignment) mode, and an MVA (Multi-domain Vertical Alignment) mode. In the horizontal electric field type of liquid crystal display panel, a pair of electrodes is disposed on the inner surface of one of a pair of substrates interposing a liquid crystal layer therebetween so as to be insulated from each other and a roughly horizontal electric field is applied to liquid crystal molecules. Examples of such a horizontal electric field type of liquid crystal display panel include liquid crystal display panels of an IPS (In-Plane Switching) mode in which a pair of electrodes does not overlap with each other in a plan view and an FFS (Fringe Field Switching) mode in which a pair of electrodes overlaps with each other in a plan view.

In the liquid crystal display panel of an FFS mode, a pair of electrodes including a common electrode and a pixel electrode is disposed in different layers with an insulating film interposed therebetween, slit-like apertures are formed in the common electrode or the pixel electrode close to the liquid crystal layer, and a roughly horizontal electric field is applied to the liquid crystal layer through the slit-like apertures. The liquid crystal display panel of an FFS mode has advantages such that it is possible to obtain a wide viewing angle and to improve image contrast, and thus is extensively used. As the liquid crystal display panel of an FFS mode, a liquid crystal display panel in which the pixel electrode is formed in the same layer as a TFT (Thin Film Transistor) as a switching element and a liquid crystal display panel in which the common electrode and the pixel electrode are formed on the TFT. An example of a liquid crystal display panel in which the pixel electrode is formed in the same layer as the TFT will be described below with reference to FIG. 6.

FIG. 6 is a longitudinal sectional view illustrating an array substrate in a liquid crystal display panel of an FFS mode according to the related art, which corresponds to a sub pixel.

In the array substrate of the liquid crystal display panel 60 of an FFS mode according to the related art, a gate line 62 having a gate electrode G part and a common line 63 are formed in parallel with each other on a transparent substrate 61 such as a glass substrate. A lower electrode 64 formed of a transparent conductive material is formed directly on the transparent substrate 61, and the lower electrode 64 is electrically connected to the common line 63. Therefore, the lower electrode 64 serves as a common electrode. A TFT (Thin Film Transistor) is formed in the gate electrode G part of the gate line 62 for each pixel, and an upper electrode 68 having plural slits 67 and being formed of a transparent conductive material is formed on the surface of the lower electrode 64 with a gate insulating film 65 and a passivation film 66 interposed therebetween. The upper electrode 68 is electrically connected to the drain electrode D of the TFT via a contact hole 69. Therefore, the upper electrode 68 serves as a pixel electrode. In the liquid crystal display panel 60 of an FFS mode according to the related art having the above-mentioned configuration, since the lower electrode 64, the gate line 62, and the common line 63 are formed directly on the transparent substrate 61, it is possible to reduce the number of manufacturing processes and thus to obtain a liquid crystal display panel of an FFS mode at a low cost.

However, when a scratch originally exists in the transparent substrate 61 of the above-mentioned liquid crystal display panel of an FFS mode according to the related art, the gate line 62 or the common line 63 may be disconnected due to the scratch. The disconnection of the common line 63 hardly causes any problem, since the surface of the common line 63 is covered with the lower electrode 64 and thus conductivity is maintained. However, the disconnection of the gate line 62 causes a severe defect such as display failure.

On the other hand, JP-A-2001-235763 discloses a configuration for suppressing the disconnection of the gate line 62 due to the original scratch formed in the transparent substrate 61 in the liquid crystal display panel 60 of an FFS mode according to the related art. Here, the configuration of an array substrate of a liquid crystal display panel 70 of an FFS mode disclosed in JP-A-2001-235763 will be described with reference to FIG. 7.

FIG. 7 is a longitudinal sectional view illustrating an array substrate in the liquid crystal display panel of an FFS mode disclosed in JP-A-2001-235763, which corresponds to a sub pixel.

The liquid crystal display panel 70 disclosed in JP-A-2001-235763 is equal to the above-mentioned liquid crystal display panel 60 according to the related art, in that it has a configuration in which a gate line 72 having a gate electrode G part and a common line 73 are formed in parallel with each other on a transparent substrate 71 such as a glass substrate. However, the liquid crystal display panel 70 is different from the liquid crystal display panel 60 according to the related art, in that a line part 72a formed of the same material as a lower electrode 74 is formed in a part of the gate line 72 having a gate electrode G part and the common line 73 is formed on the surface of the lower electrode 74. The other configurations of the liquid crystal display panel 70 are the same as the liquid crystal display panel 60 according to the related art and thus details thereof are not described. According to the liquid crystal display panel 70 having this configuration, since the gate line 72 having a gate electrode G part is not formed directly on the transparent substrate 71, an advantage in that the disconnection of the gate line 72 due to an original scratch formed in the transparent substrate 71 is suppressed can be derived.

### SUMMARY

However, in the liquid crystal display panel 70 disclosed in JP-A-2001-235763, the gate line 72 having a gate electrode G part and the common line 73 are formed on the surface of the lower electrode 74 by the use of a photolithography method and an etching method. That is, for example, an ITO film and an MoW film are sequentially stacked on the transparent substrate 71 and then the gate line 72 having a gate electrode G part, the common line 73 and the lower electrode 74 are formed by the use of the photolithography method and the etching method. However, at the time of forming the gate line 72 having a gate electrode G part and the common line 73, the surface of the lower electrode 74 is exposed in the course of etching the MoW film. Accordingly, since the surface of the lower electrode 74 is exposed to the etching atmosphere, the resistance value of the lower electrode 74 increases. The area of the lower electrode 74 formed at a position corresponding to an upper electrode 75 is limited in aperture ratio due to the existence of the common line 73. When it is intended to improve the aperture ratio while maintaining this configuration, the gate electrode G and the common line 73 come close to each other, thereby causing the disconnection.

Thus, it is desirable to provide a liquid crystal display panel of an FFS mode which can suppress a disconnection of a gate line due to a scratch or the like originally formed in a glass substrate and in which the surface of a lower electrode is not roughened at the time of forming the gate line and the common line.

According to an embodiment, there is provided a liquid crystal display panel having a pair of substrates opposed to each other with a liquid crystal layer interposed therebetween, one of the pair of substrates including: a plurality of gate lines and a plurality of common lines disposed to be parallel to each other; a plurality of source lines formed to intersect the gate lines and the common lines; and a plurality of switching elements formed in the vicinities of intersections of the gate lines and the source lines, respectively. Here, a lower electrode formed of a transparent conductive material and an upper electrode in which a plurality of slits are formed are stacked with an insulating film interposed therebetween for each area defined by the gate lines and the source lines, the upper electrode is electrically connected to the corresponding switching element and the lower electrode is electrically connected to the corresponding common line, the insulating film has at least a multi-layered structure of a first insulating film close to the substrate and a second insulating film close to the liquid crystal layer, the surface of the lower electrode is covered with the first insulating film, the gate lines and the common lines are formed on the surface of the first insulating film, and the common line is electrically connected to the lower electrode via a contact hole formed in the first insulating film.

According to this liquid crystal display panel, the lower electrode formed of a transparent conductive material and the upper electrode in which plural slits are formed are stacked with an insulating film interposed therebetween for each area defined by the gate lines and the source lines, the upper electrode is electrically connected to the corresponding switching element, and the lower electrode is electrically connected to the corresponding common line. Accordingly, the liquid crystal display panel operates in an FFS mode. According to this liquid crystal display panel, the insulating film can be formed of an inorganic insulating film such as silicon oxide or silicon nitride, and the upper electrode and the lower electrode can be formed of a transparent conductive material such as ITO (Indium Tin Oxide) and IZO (Indium Zinc Oxide). Examples of a switching element used in the liquid crystal display panel include a TFT using amorphous silicon as a semiconductor material, a TFT using polysilicon, a lower-temperature poly silicon (LTPS) TFT, and a thin film diode (TFD).

According to this liquid crystal display panel, the insulating film has a multi-layered structure of at least a first insulating film close to the substrate and a second insulating film close to the liquid crystal layer, the surface of the lower electrode is covered with the first insulating film, the gate line and the common line are formed on the surface of the first insulating film, and the common line is electrically connected to the lower electrode via a contact hole formed in the first insulating film. That is, according to this liquid crystal display panel, since the surface of the lower electrode is covered with the first insulating film, the surface of the lower electrode is not exposed to the etching atmosphere at the time of forming the switching element, the gate line, and the common line on the surface of the first insulating film using an etching method. Therefore, according to this liquid crystal display panel, since the surface of the lower electrode is not roughened and the resistance value of the lower electrode is hardly increased at the time of forming the gate line and the common line, it is possible to provide a liquid crystal display panel with excellent display image quality.

According to this liquid crystal display panel, since the gate line and the common line are formed on the surface of the first insulating film, the gate line and the common line do not come in direct contact with the surface of the substrate. Therefore, according to this liquid crystal display panel, even when an original scratch exists on the surface of the substrate, the scratch can be buried in the first insulating film and thus the gate line and the common line are hardly disconnected, thereby obtaining a liquid crystal display panel with high reliability. According to this liquid crystal display panel, even when the first insulating film exists between the lower electrode and the common line, the electrical connection between the lower electrode and the common line can be easily accomplished by the contact hole formed in the first insulating film.

In the liquid crystal display panel, the lower electrode may be formed all over the display area of the surface of the one substrate.

According to this liquid crystal display panel, since in particular, it is not necessary to perform a micro etching process for forming the lower electrode, it is possible to provide a liquid crystal display panel exhibiting the above-mentioned advantages.

In the liquid crystal display panel, an opening may be preferably formed at a position of the lower electrode overlapping with the corresponding gate line in a plan view.

At the position where the lower electrode and the gate line overlap with each other in a plan view, a capacitor is formed with the first insulating film interposed therebetween, but this capacitor is a parasitic capacitor and badly influences the operation of the liquid crystal display panel. However, according to this liquid crystal display panel, since an opening is formed at the position of the lower electrode overlapping with the gate line in a plan view, the parasitic capacitance thereof is greatly reduced and thus flickering or crosstalk is hardly caused. Accordingly, it is possible to obtain the advantages of the liquid crystal display panel and to provide a liquid crystal display panel with a more excellent display image quality.

In the liquid crystal display panel, the second insulating film may have a multi-layered structure and the source line may be buried in the multi-layered structure of the second insulating film.

According to this liquid crystal display panel, since the surface of the source line is covered with the insulating film and the source line and the switching element are disposed in the same layer, the surface of the switching element is covered with the insulating film. Therefore, according to this liquid crystal display panel, since the switching element and the source line are both covered with the insulating film, they are hardly influenced by the external atmosphere, thereby obtaining a liquid crystal display panel with a small variation in characteristics.

In the liquid crystal display panel, the thickness of the first insulating film may be preferably in the range of 500 to 2000 Å.

When the thickness of the first insulating film is less than 500 Å which is excessively small, an original scratch formed on the surface of the substrate can be transferred to the first insulating film as it is and thus the effect of forming the first insulating film is not exhibited. When the thickness of the first insulating film is greater than 2000 Å, the original scratch formed on the surface of the substrate can be substantially completely buried, but it takes time to form the first insulating film, which is not preferable.

Additional features and advantages are described herein, and will be apparent from the following Detailed Description and the figures.

### BRIEF DESCRIPTION OF THE FIGURES

FIG. 1 is a perspective view illustrating an array substrate of a liquid crystal display panel according to a first embodiment, which corresponds to a sub pixel.

FIG. 2 is a sectional view taken along line II-II of FIG. 1.

FIG. 3 is a sectional view taken along line III-III of FIG. 1.

FIG. 4 is a partial sectional view of a liquid crystal display panel according to a second embodiment, which corresponds to the section taken along line II-II of FIG. 1.

FIG. 5 is a partial sectional view of the liquid crystal display panel according to the second embodiment, which corresponds to the section taken along line III-III of FIG. 1.

FIG. 6 is a longitudinal sectional view illustrating an array substrate in a liquid crystal display panel of an FFS mode according to the related art, which corresponds to a sub pixel.

FIG. 7 is a longitudinal sectional view illustrating an array substrate in another liquid crystal display panel of an FFS mode according to the related art, which corresponds to a sub pixel.

### DETAILED DESCRIPTION

Hereinafter, embodiments will be described with reference to the accompanying drawings. Here, while the below-described embodiments exemplify a liquid crystal display panel of an FFS mode, they are liquid crystal display panel. In the drawings, layers or members are illustrated with different scales so that the layers or the members are recognizable from the drawings, and are not proportionate to the actual sizes.

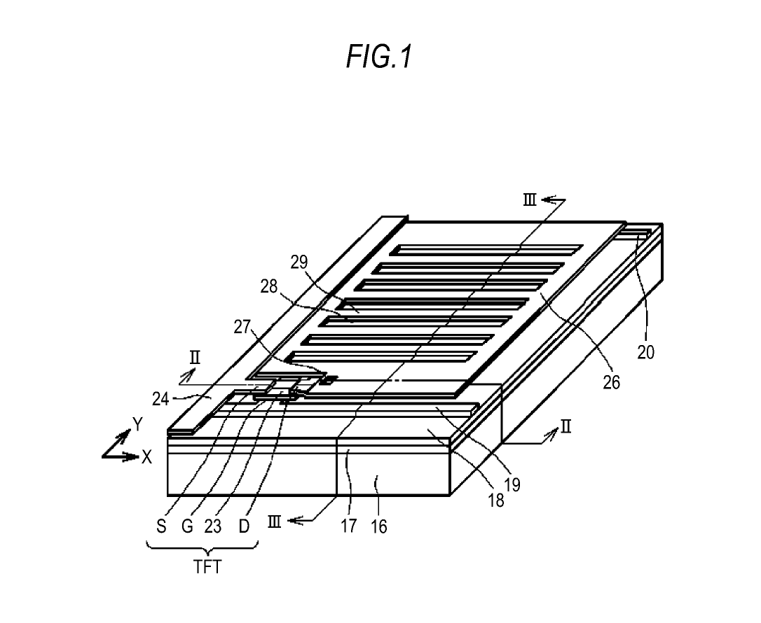

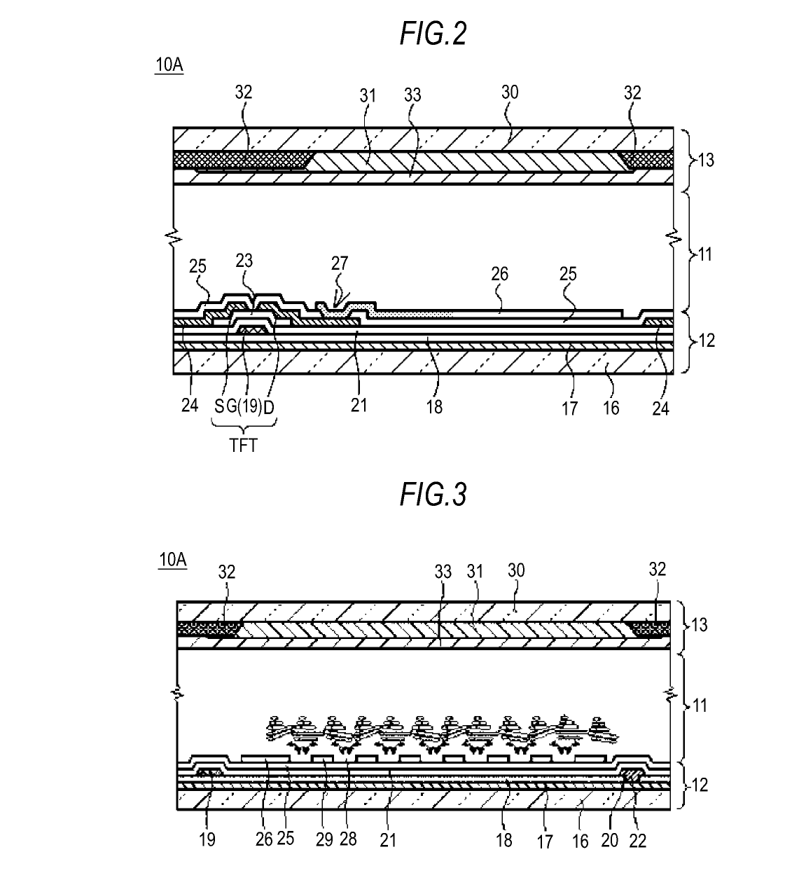

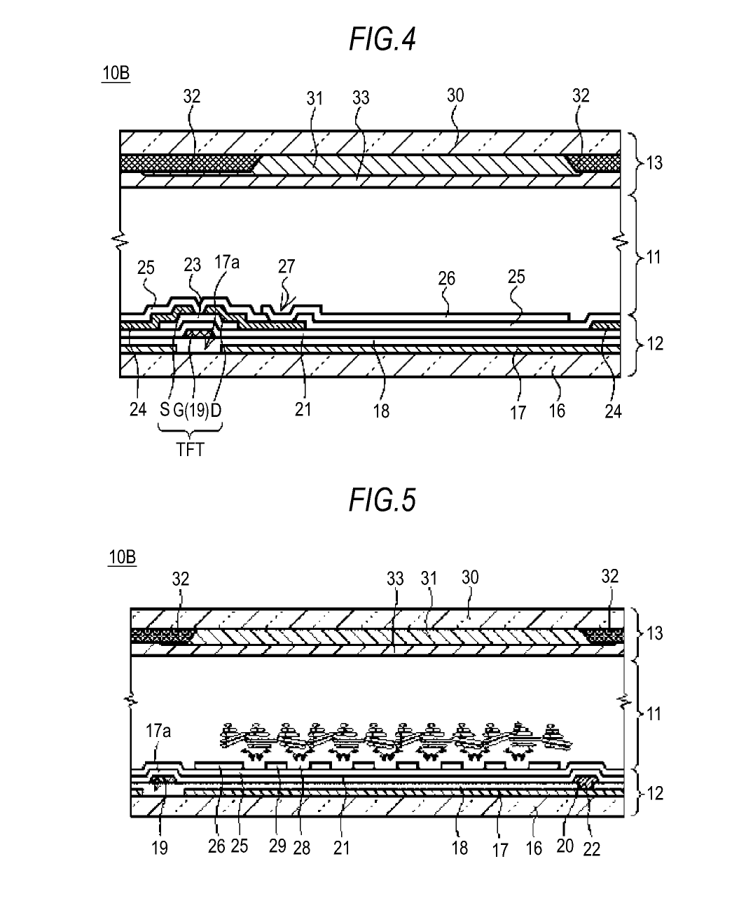

FIG. 1 is a perspective view illustrating an array substrate of a liquid crystal display panel according to a first embodiment, which corresponds to a pixel. FIG. 2 is a sectional view taken along line II-II of FIG. 1. FIG. 3 is a sectional view taken along line III-III of FIG. 1. FIG. 4 is a partial sectional view of a liquid crystal display panel according to a second embodiment, which corresponds to the section taken along line II-II of FIG. 1. FIG. 5 is a partial sectional view of the liquid crystal display panel according to the second embodiment, which corresponds to the section taken along line III-III of FIG. 1.

### First Embodiment

A liquid crystal display panel 10A according to a first embodiment will be described with reference to FIGS. 1 to 3. In the liquid crystal display panel 10A according to the first embodiment, a liquid crystal layer 11 is interposed between an array substrate 12 and a color filter substrate 13, as shown in FIGS. 2 and 3. A polarizing plate (not shown) is formed on the back surface of the array subsrate 12 and the front surface of the color filter substrate 13. Light is applied from the back surface of the array substrate 12 by a backlight (not shown).

First, the configuration of the array substrate 12 will be described. The array substrate 12 uses a first transparent substrate 16 formed of glass, quartz, or plastics as a base. A lower electrode 17 formed of a transparent conductive material such as ITO or IZO is disposed on the first transparent substrate 16. A first insulating film 18 formed of an inorganic insulating material such as silicon oxide or silicon nitride is stacked to cover the lower electrode 17. A gate line (scanning line) 19 having a gate electrode G part and a common line 20 are formed on the first insulating film 18 so as to be parallel to each other. The gate line 19 and the common line 20 are formed of an opaque metal such as aluminum metal, aluminum alloy, and molybdenum.

A second insulating film 21 formed of an inorganic insulating material such as silicon oxide and silicon nitride is formed to cover the gate line 19 and the common line 20. As shown in FIG. 3, a first contact hole 22 reaching the lower electrode 17 through the second insulating film 21 is formed. The common line 20 and the lower electrode 17 are electrically connected to each other via the first contact hole 22. Therefore, the lower electrode 17 serves as a common electrode.

A semiconductor layer 23 formed of amorphous silicon is formed on the second insulating film 21 and a source electrode S and a drain electrode D are formed to extend over the semiconductor layer 23. The semiconductor layer 23 is disposed to face a part branched from the gate line 19 via the second insulating film 21 and the part branched from the gate line 19 constitutes the gate electrode G of a TFT. The semiconductor layer 23, the source electrode S, the drain electrode D, and the gate electrode G constitute a TFT as the switching element. The source electrode S is branched from ae source line (signal line) 24. In FIG. 1, the source line 24 extends in the Y axis direction and the gate line 19 and the common line 20 extend in the X axis direction. The source line 24 and the drain electrode D are formed of an opaque metal such as aluminum metal, aluminum alloy, and molybdebum. The common line 20, the source line 24, the drain electrode D, and the exposed surface of the second insulating film 21 are covered with a third insulating film 25 formed of an inorganic insulating material such as silicon oxide or silicon nitride.

An upper electrode 26 is formed of a transparent conductive material such as ITO and IZO so as to cover the third insulating film 25. A second contact hole 27 reaching the drain electrode D through the third insulating film 25 is formed in the third insulating film 25, and the upper electrode 25 is electrically connected to the drain electrode D via the second contact hole 27. Therefore, the upper electrode 26 serves as a pixel electrode.

The upper electrode 26 includes band-like electrode portions 29 formed by a plurality of slit-like apertures (hereinafter, referred to as “slits”) extending, for example, in the X axis direction, as shown in FIG. 1. In the liquid crystal display panel 10A according to the first embodiment, an auxiliary capacitor using the lower electrode 17 and the upper electrode 26 as two electrodes and using the first to third insulating films 18, 21, and 25 interposed between both electrodes as a dielectric film is formed. The slits 28 are formed by exposing and etching the upper electrode 26 by the use of the photolithography method. An alignment film (not shown) formed of, for example, polyimide and subjected to a rubbing process in a predetermined direction is formed in the band-like electrode portions of the upper electrode 26 and the insides of the slits 28. The direction of the rubbing process is oblique about the direction of the slits 28 of the upper electrode 26 by about 3 to 25 degrees.

The color filter substrate 13 will be then described. The color filter substrate 13 includes a second transparent susbtrate 30 formed of glass, quartz, or plastics as a base. A color filter layer 31 transmitting a color light beam (R, G, B, or achromatic color) varying depending on the sub pixels and a black matrix layer 32 formed of a light-blocking material are formed on the second transparent substrate 30. An overcoating layer 33 formed of a transparent resin is formed to cover the color filter layer 31 and the black matrix layer 32, and an alignment layer (not shown) formed of, for example, polyimide and subjected to a rubbing process in a predetermined direction is formed to cover the overcoating layer 33. The rubbing direction of the alignment film in the color filter substrate 13 is different from the rubbing direction in the array substrate 12 by 180°.

The array substrate 12 and the color filter substrate 13 formed as described above are disposed to face each other, the edges are sealed with a sealing material (not shown), and a liquid crystal layer 11 is enclosed in the sealed area formed between the array substrate 12 and the color filter substrate 13, whereby the liquid crystal display panel 10A according to the first embodiment is obtained. In the liquid crystal display panel 10A according to the first embodiment, the transmission axis of the polarizing plate in the array substrate 12 and the transmission axis of the polarizing plate in the color filter substrate 13 are disposed to be perpendicular to each other. The transmission axis of the polarizing plate in the array substrate 12 is disposed to be perpendicular to the rubbing direction of the alignment film. According to this configuration, the rubbing direction of the alignment film in the array substrate intersects the main direction of the electric field generated between the lower electrode 17 and the upper electrode 26. The liquid crystal molecues having been aligned to be parallel to the rubbing direction in the initial state rotate in the main direction of the electric field and are rearranged by means of the voltage applied across the lower electrode 17 and the upper electrode 26. The light and shade of each sub pixel is displayed on the basis of the difference between the initially-aligned state and the aligned state based on the application of a voltage.

As described above, in the liquid crystal display panel 10A according to the first embodiment, the gate electrode G, the gate line 19, and the common line 20 are formed on the first insulating film 18 but is not formed directly on the first transparent substrate 16. Therefore, in the liquid crystal display panel 10A according to the first embodiment, even when an original scratch exists on the surface of the first transparent substrate 16, the scratch can be buried with the first insulating film 18 and thus the gate line 19 and the common line 20 are hardly disconnected. In addition, since the surface of the lower electrode 17 is covered with the first insulating film 18, the surface of the lower electrode 17 is not exposed to the etching atmosphere at the time of forming the TFT, the gate line 19, and the common line 20 on the surface of the first insulating film 18 using an etching method. Therefore, in the liquid crystal display panel 10A according to the first embodiment, since the surface of the lower electrode 17 is not roughened at the time of forming the gate line 19 and the common line 20 and the resistance value of the lower electrode 17 hardly increases, it is possible to obtain a liquid crystal display panel 10A with excellent display image quality.

The thickness of the first insulating film can be set to the range of 500 to 2000 Å. When the thickness of the first insulating film 18 is less than 500 Å and an original scratch exists on the surface of the first transparent substrate 16, the original scratch is transferred to the first insulating film 18 and thus the above-mentioned effect based on the formation of the first insulating film 18 is not exhibited. When the thickness of the first insulating film 18 is greater than 2000 Å and an original scratch exists on the surface of the first transparent substrate 16, the scratch can be substantially completely buried, but it takes time to form the first insulating film 18.

### Second Embodiment

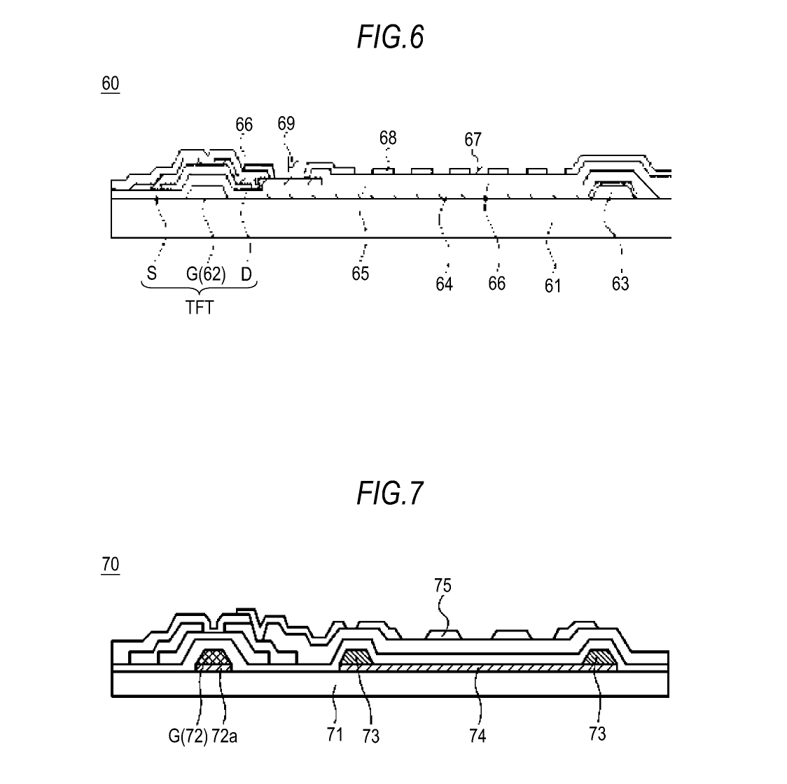

In the liquid crystal display panel 10A according to the first embodiment, the lower electrode 17 is formed substantially on the entire surface of the first transparent substrate 16 and the gate line 19 having a gate electrode G part and the commo line 20 are formed on the surface of the lower electrode 17 with the first insulating film 18 interposed therebetween. According to this configuration, since the gate line 19 and the lower electrode 17 overlap with each other in a plan view, a parasitic capacitor is formed between the gate line 19 and the lower electrode 17. The parasitic capacitor causes flickering or crosstalk and desirably is thus reduced as much as possible. Therefore, a liquid crystal display panel 10B according to a second embodiment in which a parastice capacitor is hardly formed between the gate line 19 and the lower electrode 17 will be described below with reference to FIGS. 4 and 6. Here, in FIGS. 4 to 6, the same elements as the liquid crystal display panel 10A according to the first embodiment are referenced by the same reference numerals and signs and details thereof are not described.

The configuration of the liquid crystal display panel 10B according to the second embodiment is equal to the configuration of the liquid crystal display panel 10A according to the first embodiment, except that an opening 17a is formed in the lower electrode 17 at a position overlapping with the gate line 19 having a gate electrode G part in a plan view. In the liquid crystal display panel 10B according to the second embodiment, since the lower electrode 17 does not exist under the gate line 19 having a gate electrode G part, the capacitance of the parasitic capacitor between the gate line 19 having a gate electrode G part and the lower electrode 17 is greatly reduced, compared with the liquid crystal display panel 10A according to the first embodiment. Therefore, the liquid crystal display panel 10B according to the second embodiment causes the flickering or crosstalk less than the liquid crystal display panel 10A according to the first embodiment, thereby obtaining excellent display image quality.

The portion of the opening 17a formed in the lower electrode 17 may be left without any process, but may be buried with a resin material or the like because the surface of the first insulating film 18 may not be completely flat even by burying the opening 17a due to the step difference based on the edge of the lower electrode 17 and the small thickness of the first insulating film 18 in the range of 500 Å to 2000 Å.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A liquid crystal display panel comprising:
a pair of substrates opposed to each other with a liquid crystal layer interposed therebetween, one of the pair of substrates including
a plurality of gate lines and a plurality of common lines disposed parallel to each other;
a plurality of source lines formed to intersect the gate lines and the common lines; and
a plurality of switching elements formed in the vicinities of intersections of the gate lines and the source lines, respectively,
wherein a lower electrode formed of a transparent conductive material and an upper electrode in which a plurality of slits are formed are stacked with an insulating film interposed therebetween for each area defined by the gate lines and the source lines,
wherein the upper electrode is electrically connected to the corresponding switching element and the lower electrode is electrically connected to the corresponding common line,
wherein the insulating film has at least a multi-layered structure of a first insulating film close to the substrate and a second insulating film close to the liquid crystal layer,
wherein the surface of the lower electrode is covered with the first insulating film,
wherein the gate lines and the common lines are formed on the surface of the first insulating film, and
wherein the common line is electrically connected to the lower electrode via a contact hole formed in the first insulating film.

2. The liquid crystal display panel according to claim 1, wherein the lower electrode is formed over the entire display area of the one substrate.

3. The liquid crystal display panel according to claim 2, wherein an opening is formed at a position of the lower electrode overlapping with the corresponding gate line in a plan view.

4. The liquid crystal display panel according to claim 1, wherein the second insulating film has a multi-layered structure and the source line is formed in the multi-layered structure of the second insulating film.

5. The liquid crystal display panel according to claim 1, wherein the thickness of the first insulating film is in the range of 500 to 2000 Å.
